(19) United States
(12) Patent Application Publication
(10) Pub. No.: US 2019/0140806 A1
(43) Pub. Date: May 9, 2019

(54) Radio Network Node, a Wireless Device and Methods therein for Reference Signal Configuration

(71) Applicant: TELEFONAKTIEBOLAGET LM ERICSSON (PUBL), Stockholm (SE)

(72) Inventors: Håkan ANDERSSON, Linköping (SE); Mattias FRENNE, Uppsala (SE); Johan FURUSKOG, Stockholm (SE); Niclas WIBERG, Linköping (SE); Qiang ZHANG, Täby (SE)

(73) Assignee: Telefonaktiebolaget LM Ericsson (publ), Stockholm (SE)

(21) Appl. No.: 16/095,435

(22) PCT Filed: Apr. 12, 2017
(86) PCT No.: PCT/SE2017/050365

§ 371 Date: Oct. 22, 2018

Related U.S. Application Data
(60) Provisional application No. 62/326,015, filed on Apr. 22, 2016.

(51) Int. Cl. H04L 5/00; H04L 27/26

(52) U.S. Cl. CPC H04L 5/0091; H04L 5/0051; H04L 27/2605; H04L 5/0007; H04L 27/2662; H04L 27/2666

(57) ABSTRACT

A Radio Network Node (RNN) 210 and a method therein for configuration of Demodulation Reference Signals (DMRSs) of a wireless device 208. The RNN 210 and the wireless device 208 are operating in a wireless communications network 200. The RNN indicates a DMRS configuration to the wireless device, which DMRS configuration is dynamically configurable to relate to one or more out of a first Orthogonal Frequency-Division Multiplexing (OFDM) symbol comprising DMRSs for a first transmission; and a second OFDM symbol comprising DMRSs for the first transmission.

### TECHNICAL FIELD

Embodiments herein relate generally to a Radio Network Node (RNN), a wireless device and to methods therein. In particular, embodiments relate to Reference Signal (RS) configuration, and especially to high-speed Demodulation Reference Signal (DMRS) configuration.

### BACKGROUND

Communication devices such as terminals are also known as e.g. User Equipments (UE), mobile terminals, stations (STAs), wireless devices, wireless terminals and/or mobile stations. Communications devices are enabled to communicate wirelessly in a wireless communications network, such as a Wireless Local Area Network (WLAN), or a cellular communications network sometimes also referred to as a cellular radio system or cellular networks. The communication may be performed e.g. between two communications devices, between a communications device and a regular telephone and/or between a communications device and a server via an access network and possibly one or more core networks, comprised within the wireless communications network.

The above communications devices may further be referred to as mobile telephones, cellular telephones, laptops, or tablets with wireless capability, just to mention some further examples. The communications devices in the present context may be, for example, portable, pocket-storable, hand-held, computer-comprised, or vehicle-mounted mobile devices, enabled to communicate voice and/or data, via the access network, such as a Radio Access Network (RAN), with another entity, such as another terminal or a server.

The communications network covers a geographical area which is divided into geographical subareas, such as coverage areas, cells or clusters. In a cellular communications network each cell area is served by an access node such as a base station, e.g. a Radio Base Station (RBS), which sometimes may be referred to as e.g. “eNB”, “eNodeB”, “NodeB”, “B node”, or Base Transceiver Station (BTS), depending on the technology and terminology used. The base stations may be of different classes such as e.g. macro eNodeB, home eNodeB, micro eNode B or pico base station, based on transmission power, functional capabilities and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the communications devices within range of the base stations. In the context of this disclosure, the expression Downlink (DL) is used for the transmission path from the base station to the communications device. The expression Uplink (UL) is used for the transmission path in the opposite direction i.e. from the communications device to the base station.

A Universal Mobile Telecommunications System (UMTS) is a third generation (3G) telecommunication network, which evolved from the second generation (2G) Global System for Mobile Communications (GSM). The UMTS Terrestrial Radio Access Network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks, and investigate enhanced data rate and radio capacity. In some RANs, e.g. as in UMTS, several radio network nodes may be connected, e.g., by landlines or microwave, to a controller node, such as a Radio Network Controller (RNC) or a Base Station Controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3GPP and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface. EPS is the Evolved 3GPP Packet Switched Domain.

3GPP LTE radio access standard has been written in order to support high bitrates and low latency both for uplink and downlink traffic. All data transmission is in LTE controlled by the radio base station.

Advanced Antenna Systems (AASs) is an area where technology has advanced significantly in recent years and where we also foresee a rapid technology development in the years to come. Hence it is natural to assume that AASs in general and massive Multiple Input Multiple Output (MIMO) transmission and reception in particular will be a cornerstone in a future Fifth Generation (5G) system.

Demodulation Reference Signals (DMRSs) are inserted in the time and frequency grid in any transmission from a transmitter, e.g. a Radio Network Node (RNN), to a receiver, e.g. a wireless device, when the transmission requires channel estimation at the receiver. The transmission may be a transmission comprising data or control information.

The DMRSs consist of reference signals that are known to the receiver at the time of reception. The configuration of the DMRSs may be semi-static, e.g. it may be changed via higher-layer signaling, or it may be dynamic via control signaling e.g. Downlink Control Information (DCI) signaling using for example a physical channel.

By the expression “semi-static configuration” when used in this disclosure is meant that the configuration may be static, e.g. the same, between a first higher-layer signal and second-higher layer signal, and that it may be changed by the second higher-layer signal. Thus, the configuration is changeable by higher-layer signaling but the configuration is kept unchanged during a time period between two higher-layer signals.

Further, by the expression “higher-layer signaling” when used in this disclosure is meant signaling different from control signaling. For example, higher-layer signaling is signaling using a transport channel, a logical channel or a radio bearer. Thus, the expression higher-layer signaling is used for signaling in a data link layer, a network layer, a transport layer, a session layer, a presentation layer or an application layer.

The DMRSs are typically spread out over the time/frequency grid of a transmission in an Orthogonal Frequency Division Multiplexing (OFDM) system to facilitate good channel estimates over a whole resource block. One resource block comprises 12 subcarriers sent during one slot of 0.5 ms, and one slot comprises 7 OFDM symbols.

The DMRSs are typically also used for estimation of time and/or frequency errors. However, two or more DMRSs in the same OFDM symbol but placed on different frequency positions, e.g. on different subcarriers, only enable time-error estimates.

In various forums working with the specification of 5G, there are DMRS-formats proposed that only contain DMRSs in one OFDM symbol. Typically, the DRMSs are comprised in an early OFDM symbol, e.g. in a third OFDM symbol, which facilitates early channel estimates during the reception of the subframe, cf. FIG. 1. FIG. 1 exemplifies DMRSs for one antenna port configuration in one subframe shown over two adjacent Physical Resource Blocks (PRBs) PRB1, PRB2. In FIG. 1, some first DMRSs for a first transmission on a first antenna port are placed on every second subcarrier, shown as filled squares, while the positions marked with x are reserved for some second DMRSs of another transmission, e.g. a second transmission, on a second antenna port. Thus, all DMRSs are comprised in a single OFDM symbol, e.g. the OFDM symbol number 2, but on different subcarriers.

The DMRS-based design may be used for either or both of uplink data reception, e.g. on a Physical Uplink Shared Channel (PUSCH), and downlink data reception, e.g. on a Physical Downlink Shared Channel (PDSCH).

According to developments of wireless communications networks an improved manner of providing DMRSs is needed for improving the performance of the wireless communications network.

### SUMMARY

An object of embodiments herein is to address at least some drawbacks with the prior art and to improve the performance in a communications network.

According to one aspect of embodiments herein, the object is achieved by a method performed by a Radio Network Node (RN N) for configuring Reference Signals (RSs), e.g. Demodulation RSs (DMRSs) in a wireless communications network. The RNN and a wireless device are operating in the wireless communications network.

The RNN indicates a DMRS configuration to the wireless device. The DMRS configuration is dynamically configurable to relate to one or more out of: a first OFDM symbol comprising DMRSs for a first transmission and a second OFDM symbol comprising DMRSs for the first transmission.

The RNN may transmit DMRSs to the wireless device in accordance with the DMRS configuration.

According to another aspect of embodiments herein, the object is achieved by a Radio Network Node (RNN) for configuring Reference Signals (RSs), e.g. Demodulation RSs (DMRSs) in a wireless communications network. The RNN and a wireless device are configured to operate in the wireless communications network.

The RNN is configured to indicate a DMRS configuration to the wireless device. The DMRS configuration is dynamically configurable to relate to one or more out of: a first OFDM symbol comprising DMRSs for a first transmission and a second OFDM symbol comprising DMRSs for the first transmission.

The RNN may be configured to transmit DMRSs to the wireless device in accordance with the DMRS configuration.

According to another aspect of embodiments herein, the object is achieved by a method performed by a wireless device for receiving RSs, e.g. DMRSs. The wireless device and a Radio Network node (RNN) are operating in a wireless communications network.

The wireless device receives, from the RNN, an indication of a DMRS configuration. The DMRS configuration is dynamically configurable to relate to one or more out of: a first OFDM symbol comprising DMRSs for a first transmission and a second OFDM symbol comprising DMRSs for the first transmission.

Further, the wireless device may receive DMRSs transmitted in accordance with the indicated DMRS configuration.

According to another aspect of embodiments herein, the object is achieved by a wireless device for receiving RSs, e.g. DMRSs. The wireless device and a Radio Network node (RNN) are configured to operate in a wireless communications network.

The wireless device is configured to receive, from the RNN, an indication of a DMRS configuration. The DMRS configuration is dynamically configurable to relate to one or more out of: a first OFDM symbol comprising DMRSs for a first transmission and a second OFDM symbol comprising DMRSs for the first transmission.

Further, the wireless device may be configured to receive DMRSs transmitted in accordance with the indicated DMRS configuration.

According to another aspect of embodiments herein, the object is achieved by a computer program, comprising instructions which, when executed on at least one processor, causes the at least one processor to carry out the method performed by the RNN

According to another aspect of embodiments herein, the object is achieved by a computer program, comprising instructions which, when executed on at least one processor, causes the at least one processor to carry out the method performed by the wireless device.

According to another aspect of embodiments herein, the object is achieved by a carrier comprising the computer program, wherein the carrier is one of an electronic signal, an optical signal, a radio signal or a computer readable storage medium.

Since the RNN indicates the DMRS configuration to the wireless device, which DMRS configuration is dynamically configurable to relate to one or more out of a first OFDM symbol comprising DMRSs of the first transmission and a second OFDM symbol comprising DMRSs of the first transmission, the wireless device will have knowledge about how DMRSs will be transmitted, whereby an accuracy of a frequency-error estimation may be varied. By for example, transmitting DMRSs in two or more different OFDM symbols an improved frequency-error estimation may be performed by the wireless device. This results in an improved performance in the communications network.

Thus, an advantage with embodiments herein is that they provide an improved frequency-error estimation.

Another advantage with embodiments herein is that they enables the signaling of the presence of at least a second set of DMRSs in one or more additional OFDM symbols, e.g. in the one or more second OFDM symbols. Depending on the type of signaling used, a second set of DMRSs may be turned on and off as needed for a given wireless device. For low speed and/or time-critical packets, a single OFDM is indicated and used.

Another advantage with embodiments herein is that multiple OFDM symbols for channel estimation enable a possibility to dynamically utilize a much-improved frequency-error estimation, which is of particular importance for high-speed wireless devices.

### BRIEF DESCRIPTION OF DRAWINGS

Examples of embodiments herein are described in more detail with reference to attached drawings in which:

FIG. 1 schematically illustrates DMRSs for one antenna port configuration in one subframe shown over two adjacent Physical Resource Blocks (PRBs);

FIG. 2 schematically illustrates embodiments of a wireless communications network;

FIG. 3 is a combined flowchart and signaling scheme according to some embodiments;

FIG. 4 is a flowchart schematically illustrating embodiments of a method performed by a Radio Network Node;

FIG. 5 is a block diagram schematically illustrating embodiments of a Radio Network Node;

FIG. 6 schematically illustrates a first exemplary DMRS configuration according to some embodiments;

FIG. 7 schematically illustrates a second exemplary DMRS configuration according to some embodiments;

FIG. 8 is a flowchart schematically illustrating embodiments of a method performed by a wireless device; and

FIG. 9 is a block diagram schematically illustrating embodiments of a wireless device.

### DETAILED DESCRIPTION

As part of developing embodiments herein, some problems with the state of the art communications networks will first be identified and discussed.

A problem with having DMRSs in only one OFDM symbol is that when a receiver, e.g. a wireless device, moves at a high speed, it becomes very difficult for the receiver to perform channel estimation, since it is not possible for the receiver to perform accurate frequency-error estimation, or at least the ability to perform accurate frequency-error estimation is limited, due to the presence of the DMRSs in only one OFDM symbol. As previously mentioned, the reason is that DMRSs in the same OFDM symbol but placed on different frequency positions, e.g. on different subcarriers, only enable time-error estimates. In general, when there is only one OFDM symbol comprising one or more DMRSs it is difficult to perform frequency-error estimation.

An object of embodiments herein is therefore how to provide an improved performance in a wireless communications network.

The object is achieved by some embodiments herein providing for DMRSs on the same subcarriers but placed in two or more different OFDM symbols whereby frequency-error estimates are enabled.

Further, some embodiments herein relates to a RNN for configuring DMRSs and to a wireless device for enable configuring of DMRSs.

Note that although terminology from 3GPP LTE is used in this disclosure to exemplify the embodiments herein, this should not be seen as limiting the scope of the embodiments herein to only the aforementioned system. Other wireless systems, such as for example 5G, WCDMA, Worldwide Interoperability for Microwave Access (WiMax), Ultra Mobile Broadband (UMB) and GSM, may also benefit from exploiting the ideas covered within this disclosure.

In this section, the embodiments herein will be illustrated in more detail by a number of exemplary embodiments. It should be noted that these embodiments are not mutually exclusive. Components from one embodiment may be assumed to be present in another embodiment and it will be obvious to a person skilled in the art how those components may be used in the other exemplary embodiments.

Further, the description frequently refers to wireless transmissions in the downlink, but embodiments herein are equally applicable in the uplink.

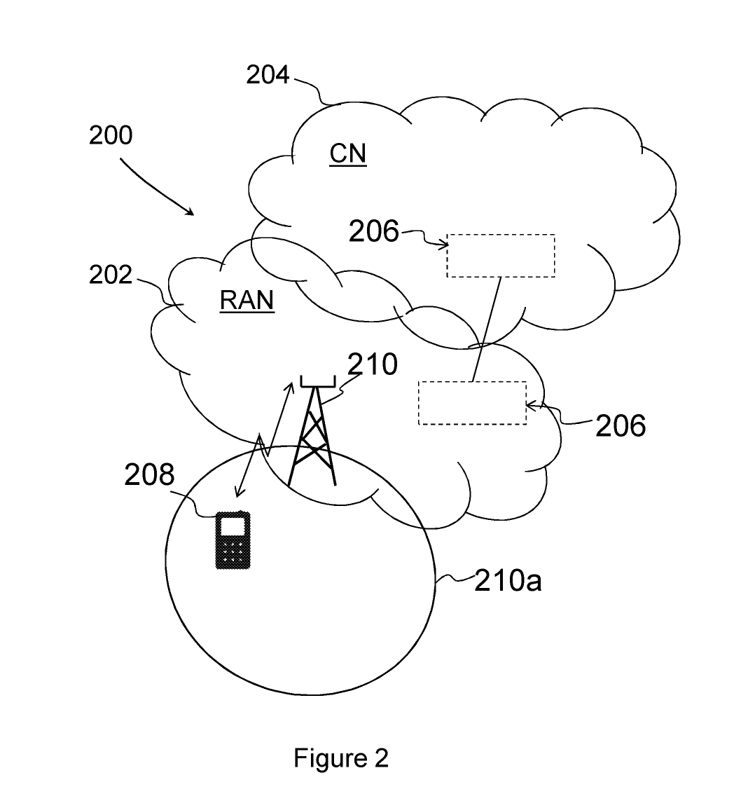

Embodiments herein relate to wireless communications network in general. A wireless communications network 200 as schematically illustrated in FIG. 2. For example, embodiments herein may be implemented in the wireless communications network 200. The wireless communications network 200 may be a cellular communications network. Further, the wireless communications network 200 may be an LTE network, a 5G network, a WCDMA network, an GSM network, any 3GPP cellular network, Wimax, or any other wireless communications network or system.

The wireless communication network 200 comprises one or more Radio Access Networks (RANs), e.g. a RAN 202, and one or more Core Networks (CNs), e.g. a CN 204. The wireless communication network 200 may use a number of different technologies, such as Wi-Fi, LTE, LTE-Advanced, 5G, WCDMA, Global System for Mobile communications/enhanced Data rate for GSM Evolution (GSM/EDGE), WiMax, or UMB, just to mention a few possible implementations. Embodiments herein relate to recent technology trends that are of particular interest in a 5G context, however, embodiments are also applicable in further development of the existing wireless communication systems such as e.g. WCDMA and LTE.

A network node 206 may be operating and/or comprised in the RAN 202 or the CN 204. In some embodiments, the network node 206 is comprised in the core network 502, and then the network node 206 may be referred to as a core network node. The network node 206 is configured to operate in the wireless communications network 200, e.g. in the core network 204.

The network node 206 may be an Evolved-Serving Mobile Location Centre (E-SMLC), a Mobile Switching Center (MSC), a Mobility Management Entity (MME), an Operation & Maintenance (O&M) node, a Serving GateWay (S-GW), a Serving General Packet Radio Service (GPRS) Node (SGSN), etc.

In the wireless communication network 200, wireless devices e.g. a wireless device 208 such as a mobile station, a non-Access Point (non-AP) STA, a STA, a user equipment and/or a wireless terminals, communicate via one or more Access Networks (AN), e.g. RAN, to one or more Core Networks (CN). Thus, the wireless device 208 is operating in the wireless communications network 200.

It should be understood by the skilled in the art that “wireless device” is a non-limiting term which means any terminal, communications device, wireless communication terminal, user equipment, Machine-Type Communication (MTC) device, Device-to-Device (D2D) terminal, or node e.g. smart phone, laptop, mobile phone, sensor, relay, mobile tablets, an Internet-of-Things (IoT) device, e.g. a Cellular IoT (CIoT) device or even a small base station communicating within a service area.

In this disclosure the terms communications device, terminal, wireless device and UE are used interchangeably. Please note the term user equipment used in this document also covers other wireless devices such as Machine-to-Machine (M2M) devices, even though they do not have any user.

The wireless communications network 200 comprises a Radio Network Node (RNN) 210 providing radio coverage over a geographical area, a service area 210a, which may also be referred to as a cell, a cluster, a beam or a beam group, of a first Radio Access Technology (RAT), such as 5G, LTE, Wi-Fi or similar. The RNN 210 may be said to operate in the wireless communications network 200. The RNN 210 may be a transmission and reception point e.g. a radio access network node such as a Wireless Local Area Network (WLAN) access point or an Access Point Station (AP STA), an access controller, a base station, e.g. a radio base station such as a NodeB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless device within the service area served by the first access point 210 depending e.g. on the first radio access technology and terminology used. The RNN 210 may be referred to as a serving radio network node and communicates with the wireless device 208 with Downlink (DL) transmissions to the wireless device 208 and Uplink (UL) transmissions from the wireless device 208. Other examples of the RNN 210 are Multi-Standard Radio (MSR) nodes such as MSR BS, network controllers, Radio Network Controllers (RNCs), Base Station Controllers (BSCs), relays, donor nodes controlling relay, Base Transceiver Stations (BTSs), Access Points (APs), transmission points, transmission nodes, Remote Radio Units (RRUs), Remote Radio Heads (RRHs), nodes in Distributed Antenna System (DAS) etc.

In this disclosure, the geographical area 210a is sometimes referred to as a coverage area, a cell or a cluster wherein the RNN 210 provides radio coverage.

Further, in this disclosure by the term “subframe” should be understood to be the smallest time unit which the RNN schedules at a single instance. In LTE, this is 1 ms. However, in 5G this time unit may be smaller and typically may depend on the configured subcarrier spacing. Furthermore, 3GPP has adopted a new terminology that in the context of 5G standardization calls this unit “slot”. This practice is not used in this disclosure.

Furthermore, in this disclosure by the term “slot” should be understood to be part of a subframe. In LTE, there are two slots making up a subframe. This notation should not be confused with the updated usage for the term “slot” that 3GPP has adopted for 5G.

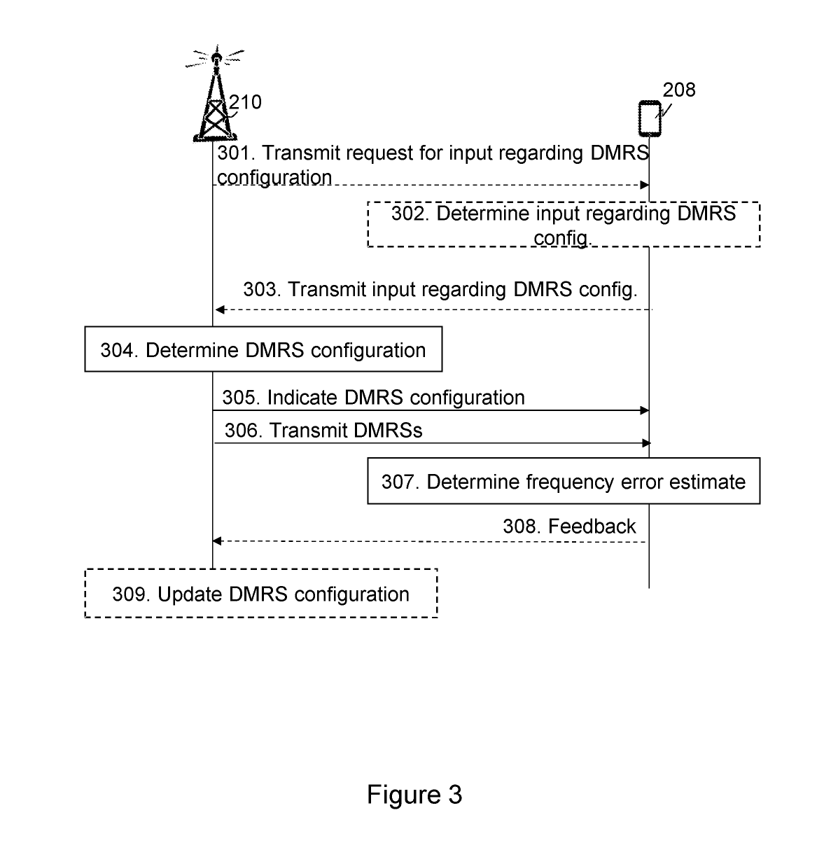

FIG. 3 is a combined flowchart and signaling scheme according to embodiments herein.

Action 301

The RNN 210 may transmit, to the wireless device 208, a request for input regarding a DMRS configuration to be used. Thus, the RNN 210 may ask the wireless device 208 for input regarding whether two or more DMRSs should be transmitted in one OFDM symbol or in a plurality of different OFDM symbols. As will be described below, if the wireless device 208 is stationary or is moving at a low speed or in the case of time-critical decoding, the input from the wireless device 208 may be that one OFDM symbol comprising the DMRSs, e.g. one OFDM symbol in the beginning of the subframe, is preferred. Examples of time-critical decoding is low-latency applications such as remote control and tactile internet applications just to mention some. However, if the wireless device 208 is moving at a high speed or in the case of non-time-critical decoding, the input from the wireless device 208 may be that two or more OFDM symbols comprising the DMRSs are preferred. Examples of non-time-critical decoding is when the data transmission is a file transfer, web browsing or non-delay sensitive applications, just to mention some.

Sometimes in this disclosure reference is made to a first OFDM symbol comprising DMRSs and to a second OFDM symbol comprising DMRSs. The first and second OFDM symbols may be any OFDM symbol comprised in a subframe. However, it should be understood that the number of OFDM symbols comprising DMRSs may be more than two. That is, some embodiments herein relate to a plurality of OFDM symbols comprising DMRSs.

Action 302

The wireless device 208 may determine a DMRS configuration or an input regarding the DMRS configuration, e.g. the wireless device 208 may determine whether one OFDM symbol, e.g. a first OFDM symbol, or several OFDM symbols, e.g. one or more second OFDM symbols, comprising DMRSs are preferred. The DMRS configuration may be referred to as relating to the first OFDM symbol comprising DMRSs and to the one or more second OFDM symbols comprising DMRSs.

Action 303

The wireless device 208 may transmit, to the RNN 210, input regarding the DMRS configuration as a response to the request received.

Action 304

The RNN 210 may determine the DMRS configuration to be used. In some embodiments, the RNN 210 determines the DMRS configuration based on the input regarding the DMRS configuration received from the wireless device 208. Alternatively or additionally, the RNN 210 may determine the DMRS configuration based on information relating to performance, e.g. to spectral efficiency, for different DMRS configurations.

The expression “spectral efficiency” when used in this disclosure relates to the information rate that may be transmitted over a given bandwidth in a communications system, e.g. the wireless communications network 200. The terms “spectral efficiency”, “spectrum efficiency”, and “bandwidth efficiency” may be used interchangeably in this disclosure.

As will be described below, the DMRS configuration may be dynamically configurable to relate to one or more out of a first OFDM symbol comprising DMRSs for a first transmission, and a second OFDM symbol comprising DMRSs for the first transmission.

Action 305

The RNN 210 indicates, to the wireless device 208, the DMRS configuration to be used. For example, the RNN 210 may transmit, to the wireless device 208, an indication of the DMRS configuration to be used. The indication may be explicit or implicit. For example, the RNN 210 may explicitly transmit an indicator indicating whether at least a second OFDM symbol comprising DMRSs will be or is comprised in the transmission. The indicator may be a single bit or a flag. However, as will be described below, the RNN 210 may implicitly signal the indication based on information in a scheduling message transmitted to the wireless device 208. Further, the indication may be signaled in a Radio Resource Control (RRC) signaling.

Action 306

The RNN 210 transmits, to the wireless device 208, the DMRSs in accordance with the DMRS configuration.

Action 307

The wireless device 208 may determine a frequency-error estimate based on the received DMRSs.

Action 308

The wireless device 208 may transmit, to the RNN 210, the determined frequency-error estimate or information relating thereto.

Action 309

The RNN 210 may update the DMRS configuration, e.g. the RNN 210 may change from a single OFDM symbol comprising the DMRSs to multiple OFDM symbols comprising the DMRSs, or vice versa.

The RNN 210 may perform the update of the DMRS configuration based on the frequency-error estimate received from the wireless device 208.

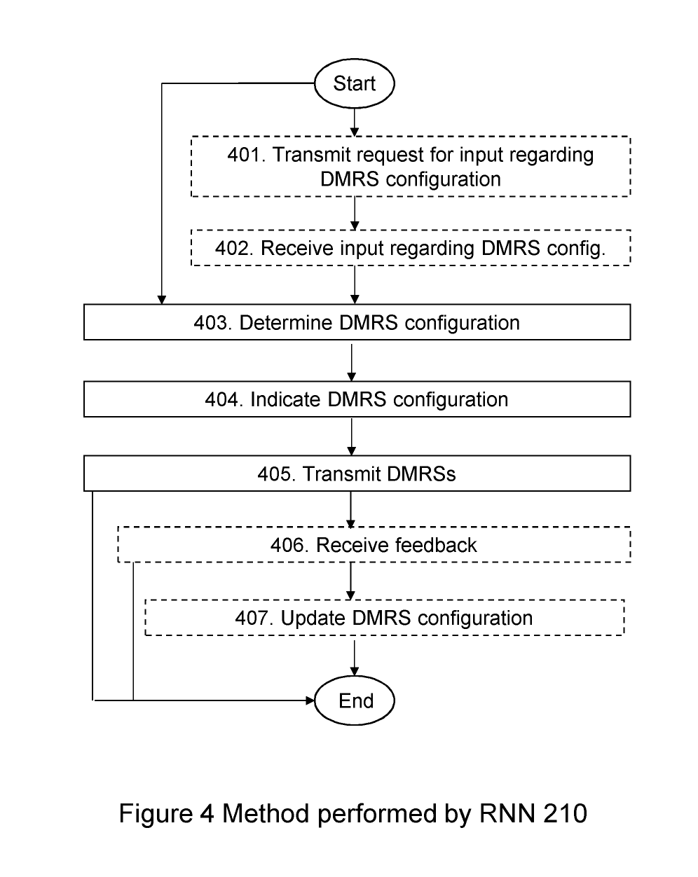

Examples of methods performed by the RNN 210 for configuring RS, e.g. DMRS, will now be described with reference to flowchart depicted in FIG. 4. As previously mentioned, the RNN 210 and the wireless device 208 are operating in the wireless communications network 200.

The methods comprise one or more of the following actions. Thus one or more of the actions may be optional. It should be understood that the actions may be taken in any suitable order and that some actions may be combined.

Action 401

In some embodiments, the RNN 210 transmits, to the wireless device 208, a request for input regarding a DMRS configuration. This relates to Action 301 previously above. For example and as previously mentioned, if the wireless device 208 is stationary or is moving at a low speed or in the case of time-critical decoding, the input from the wireless device 208 may be that one OFDM symbol comprising the DMRSs, e.g. one OFDM symbol in the beginning of the subframe, is preferred. However, if the wireless device 208 is moving at a high speed or in the case of non-time-critical decoding, the input from the wireless device 208 may be that two or more OFDM symbols comprising the DMRSs are preferred.

Action 402

In some embodiments, the RNN 210 receives, from the wireless device 208, input regarding the DMRS configuration. This relates to Action 303 previously above.

Action 403

The RNN 210 determines the DMRS configuration to be used. As described in relation to Action 304 above, in some embodiments, the RNN 210 determines the DMRS configuration based on the input regarding the DMRS configuration received from the wireless device 208. Alternatively or additionally, the RNN 210 may determine the DMRS configuration based on information relating to performance, e.g. to spectral efficiency, for different DMRS configurations.

As will be described below, the DMRS configuration may be dynamically configurable to relate to one or more out of a first OFDM symbol comprising DMRSs for a first transmission, and a second OFDM symbol comprising DMRSs for the first transmission.

The first and second OFDM symbols may be comprised in a single subframe.

Further, as will be described below and in some embodiments, the first OFDM symbol is located in a beginning of the subframe and the second OFDM symbol is located in an end of the subframe.

Furthermore, as will be described below and in some embodiments, DMRSs of a first set of DMRSs for the first transmission on a first antenna port are placed on every second subcarrier of the first OFDM symbol, and wherein DMRSs of a second set of DMRSs for the first transmission are placed on every second subcarrier of the second OFDM symbol.

Yet further, as will be described below and in some embodiments, DMRSs of a first set of DMRSs for the first transmission on a first antenna port are placed on every fourth subcarrier of the first OFDM symbol, and wherein DMRSs of a second set of DMRSs for the first transmission are placed on every fourth subcarrier of the second OFDM symbol.

Action 404

The RNN 210 indicates, to the wireless device 208, the DMRS configuration to be used. For example, the RNN 210 may transmit, to the wireless device 208, an indication of the DMRS configuration to be used. Thereby, informing the wireless device 208 about the DMRS configuration to be used. Thus, when receiving a transmission, e.g. the first transmission, the wireless device 208 will have knowledge about how DMRSs are transmitted, whereby an improved frequency-error estimation may be performed by the wireless device. This relates to Action 305 previously described.

Action 405

The RNN 210 transmits, to the wireless device 208, the DMRSs in accordance with the DMRS configuration. This relates to Action 306 previously described.

Action 406

In some embodiments, the RNN 210 receives, from the wireless device 208, a determined frequency-error estimate or information relating thereto. This relates to Action 308 previously described.

It should also be understood that the RNN 210 may receive, from the wireless device 208, feedback relating to the DMRSs in accordance with the DMRS configuration.

Further, it should be understood that in some embodiments, wherein the wireless device 208 transmits DMRS in accordance with a DMRS configuration, the RNN 210 may receive, from the wireless device 208, the DMRSs transmitted in accordance with the DMRS configuration.

Action 407

The RNN 210 may update the DMRS configuration, e.g. the RNN 210 may change from a single OFDM symbol comprising the DMRSs to multiple OFDM symbols comprising the DMRSs, or vice versa. Thus, the DMRS configuration is dynamically configurable to relate to one or more out of a first OFDM symbol comprising DMRSs for a first transmission, and a second OFDM symbol comprising DMRSs for the first transmission.

The RNN 210 may perform the update of the DMRS configuration based on the frequency-error estimate received from the wireless device 208. This relates to Action 309 previously described.

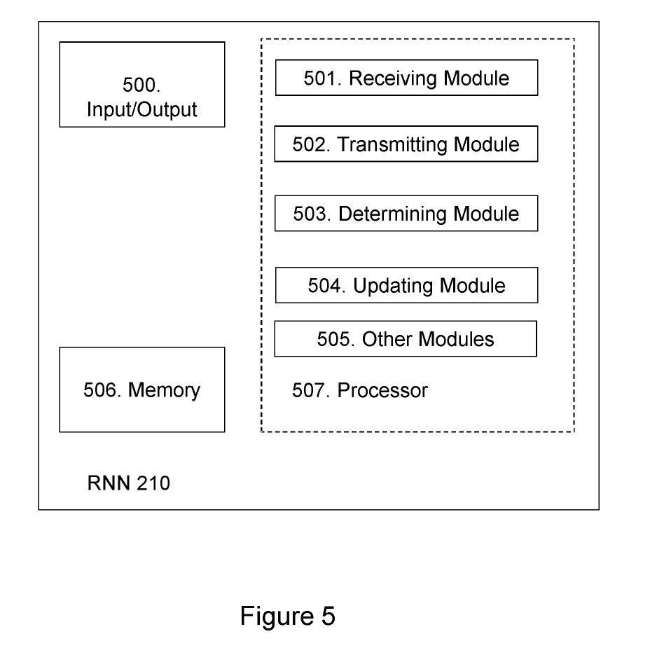

To perform the method for configuring RSs, e.g. DMRSs, the RNN 210 may be configured according to an arrangement depicted in FIG. 5. As previously mentioned, the RNN 210 and the wireless device 208 are configured to operate in the wireless communications network 200.

In some embodiments, the RNN 210 comprises an input and output interface 500 configured to communicate with one or more the wireless devices, e.g. the wireless devices 208, and one or more network nodes, e.g. the network node 206 or a neighbour RNN (not shown). The input and output interface 500 may comprise a wireless receiver (not shown) and a wireless transmitter (not shown).

The RNN 210 is configured to receive, e.g. by means of a receiving module 501 configured to receive, transmissions from the network node 206, e.g. the E-SMLC, or from the wireless device 208. The receiving module 501 may be implemented by or arranged in communication with a processor 507 of the RNN 210. The processor 507 will be described in more detail below.

For example, the RNN 210 may be configured to receive, from the wireless device 208, input regarding a DMRS configuration.

In some embodiments, the RNN 210 may be configured to receive, from the wireless device 208, a determined frequency-error estimate or information relating thereto.

It should also be understood that the RNN 210 may be configured to receive, from the wireless device 208, feedback relating to the DMRSs in accordance with the DMRS configuration. Further, it should be understood that in some embodiments, wherein the wireless device 208 is configured to transmit DMRS in accordance with a DMRS configuration, the RNN 210 may be configured to receive, from the wireless device 208, the DMRSs transmitted in accordance with the DMRS configuration.

The RNN 210 is configured to transmit, e.g. by means of a transmitting module 502 configured to transmit, transmissions to the wireless device 208. The transmitting module 502 may be implemented by or arranged in communication with the processor 507 of the RNN 210.

For example, the RNN 210 may be configured to transmit, to the wireless device 208, a request for input regarding a DMRS configuration.

In some embodiments, the RNN 210 is configured to transmit, to the wireless device 208, an indication of the DMRS configuration to be used.

The RNN 210 is configured to transmit, to the wireless device 208, the DMRSs in accordance with the DMRS configuration.

The RNN 210 is configured to determine, e.g. by means of a determining module 503 configured to determine, a configuration of RS, e.g. a DMRS configuration. The determining module 503 may be implemented by or arranged in communication with the processor 507 of the RNN 210.

The RNN 210 is configured to determine the DMRS configuration to be used. As described in relation to Action 304 above, in some embodiments, the RNN 210 is configured to determine the DMRS configuration based on the input regarding the DMRS configuration received from the wireless device 208. Alternatively or additionally, the RNN 210 may be configured to determine the DMRS configuration based on information relating to performance, e.g. to spectral efficiency, for different DMRS configurations.

The RNN 210 may be configured to update, e.g. by means of an updating module 504 configured to update, an RS configuration, e.g. a DMRS configuration. The obtaining module 504 may be implemented by or arranged in communication with the processor 507 of the RNN 210.

The RNN 210 may be configured to update the DMRS configuration, e.g. the RNN 210 may be configured to change from a single OFDM symbol comprising the DMRSs to multiple OFDM symbols comprising the DMRSs, or vice versa.

The RNN 210 may be configured to perform, e.g. by one or more other modules 505, one or more other actions described herein.

The RNN 210 may also comprise means for storing data. In some embodiments, the RNN 210 comprises a memory 506 configured to store the data. The data may be processed or non-processed data and/or information relating thereto. The memory 506 may comprise one or more memory units. Further, the memory 506 may be a computer data storage or a semiconductor memory such as a computer memory, a read-only memory, a volatile memory or a non-volatile memory. The memory is arranged to be used to store obtained information, data, configurations, schedulings, and applications etc. to perform the methods herein when being executed in the RNN 210.

Embodiments herein for configuring RS, e.g. DMRS, may be implemented through one or more processors, such as the processor 507 in the arrangement depicted in FIG. 5, together with computer program code for performing the functions and/or method actions of embodiments herein. The program code mentioned above may also be provided as a computer program product, for instance in the form of a data carrier carrying computer program code for performing the embodiments herein when being loaded into the RNN 210. One such carrier may be in the form of an electronic signal, an optical signal, a radio signal or a computer-readable storage medium. The computer-readable storage medium may be a CD ROM disc or a memory stick.

The computer program code may furthermore be provided as program code stored on a server and downloaded to the RNN 210.

Those skilled in the art will also appreciate that the input/output interface 500, the receiving module 501, the transmitting module 502, the determining module 503, and the updating module 504, and one or more other modules 505 above may refer to a combination of analog and digital circuits, and/or one or more processors configured with software and/or firmware, e.g. stored in the memory 506, that when executed by the one or more processors such as the processors in the RNN 210 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

Some embodiments herein comprise configuring, e.g. dynamically configuring, whether DMRSs associated with an antenna port used for data demodulation is mapped to a single OFDM symbol or to multiple OFDM symbols in a single subframe. This relates to Actions 304 and 403 previously described.

For example, in some embodiments herein a transmitter, e.g. the RNN 210, configures, e.g. dynamically configures, whether DMRSs are mapped to a single OFDM symbol or to multiple OFDM symbols within a single subframe. As mentioned, the DMRSs are associated with an antenna port used for data demodulation. Thus, the DMRS configuration may be dynamically configurable to relate to one or more out of a first OFDM symbol comprising DMRSs for a first transmission, and a second OFDM symbol comprising DMRSs for the first transmission.

By dynamically configuring the mapping of DMRSs to one or more OFDM symbols, the DMRS-positions, e.g. the positions of the DMRSs in the one or more OFDM symbols, may be adapted to a speed of a receiver, e.g. the wireless device 208. Thus, the DMRS-positions may be adapted to low terminal speed, e.g. when the receiver is stationary or moving slowly, and to high terminal speed, e.g. when the receiver is moving with a moving car or train, respectively.

Low or zero-speed or time-critical decoding corresponds to decoding of a single OFDM symbol within a subframe or a Transmission-Time Interval (TTI), which OFDM symbol comprises the DMRSs. This allows for an early decoding start of the data since the channel estimate is available after measuring the channel on the single OFDM symbol.

By the expression “time-critical decoding” when used in this disclosure is meant decoding of time critical data such as for low-latency applications like remote control and tactile internet applications.

The TTI is the minimum time between data units, e.g. Medium-Access Control (MAC) Protocol Data Units (PDUs), being passed down to the physical layer. It is usually also the time over which data blocks are encoded for physical transmission. Further, the TTI may be a multiple of the subframe, e.g. a multiple of the radio subframe length. However, sometimes in this disclosure the terms “subframe” and “TTI” are used interchangeably.

High-speed or non-time-critical decoding corresponds to decoding of multiple OFDM symbols within a subframe or a TTI, which OFDM symbols comprise the DMRSs. In such scenario, a DMRS antenna port is using DMRS Resource Elements (REs) in at least two different OFDM symbols as to allow for channel interpolation or extrapolation in the time direction in the receiver, e.g. the wireless device 208, for that particular antenna port. In case of multiple OFDM symbols carrying the DMRSs, early decoding may not be possible since the whole subframe may have to be received before decoding may start. This may be the case when the OFDM symbols carrying the DMRSs are located in the beginning and at the end of the subframe. In all cases, all the OFDM-symbols comprising DMRS should be received so that the channel estimate may be calculated. However, OFDM-symbols with data trailing the OFDM-symbol comprising the last DMRS may be received after the decoding of the OFDM symbol has begun.

This relates to Actions 301-304, and to 401-403 described above. For example, in those actions it is described that the RNN 210 requests the wireless device 208 for input regarding the DMRS configuration, the wireless device 208 determines the input which may depend on its speed or requirements on time-critical decoding, e.g. on a service class, and wherein it is further described that the RNN 210 may determine the DMRS configuration based on the received input.

This also relates to Actions 801-803 which will be described below.

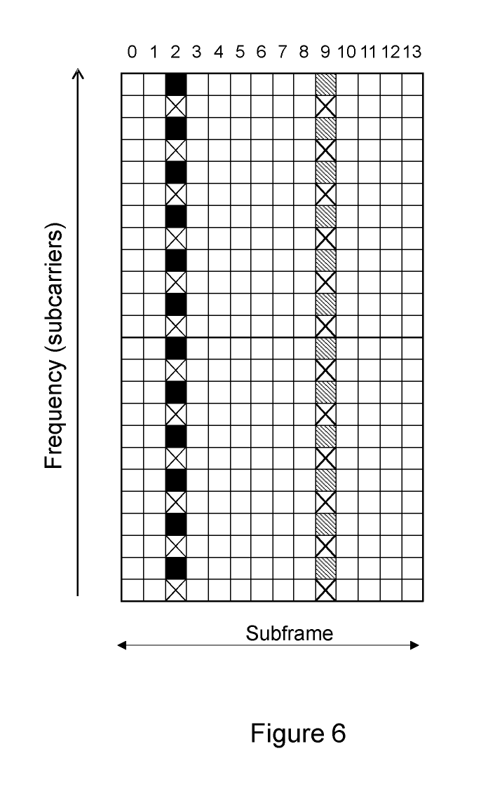

In some embodiments, an indicator is introduced to indicate whether or not one or more second OFDM symbols comprising DMRSs are available in addition to the first OFDM symbol comprising DMRSs. Thus, the indicator indicates whether at least a second OFDM symbol comprising DMRSs is comprised in a transmission, cf. FIG. 6. This relates to Actions 305 and 404 described above, wherein the RNN 210 may transmit an indication of the DMRS configuration. This also relates to Actions 804 which will be described below. As previously mentioned, the indication may be explicit or implicit. FIG. 6 schematically illustrates a first exemplary DMRS-configuration according to some embodiments disclosed herein.

In FIG. 6, a first set of DMRSs for a first transmission on a first antenna port are placed on every second subcarrier on the first OFDM symbol, e.g. the OFDM symbol number 2. The DMRSs of the first set of DMRSs are shown as filled squares in FIG. 6. A second set of DMRSs for the first transmission on the first antenna port are placed on every second subcarrier on the second OFDM symbol, e.g. the OFDM symbol number 9. The DMRSs of second set of DMRSs RE indicated with downward diagonal lines.

In FIG. 6, the positions marked with x are reserved for DMRSs, e.g. a third set of DMRSs and a fourth set of DMRSs, of another transmission, e.g. a second transmission, on a second antenna port. Thus, the third set of DMRSs may be placed on the first OFDM symbol, and the fourth set of DMRSs may be placed on the second OFDM symbol.

In some embodiments, the indicator is comprised in control information, e.g. Downlink Control Information (DCI), scheduling the data transmission.

Alternatively, in some embodiments the indicator is semi-statically configured using higher-layer signaling. By the expression “semi-statically configured using higher layer signaling” when used in this disclosure is meant that the indicator is configured to be static, e.g. the same or unchanged, between two higher-layer signalings, e.g. between a first higher-layer signal and a second higher-layer signal, and that the indicator may be changed by the second higher-layer signal.

The second OFDM symbol comprising the DMRSs may be placed in the last OFDM symbol of a Physical Downlink Shared Channel (PDSCH) or of a Physical Uplink Shared Channel (PUSCH) region of the subframe to avoid the need for channel extrapolation in the receiver, e.g. the wireless device 208 in case of downlink communication using the PDSCH. Correspondingly, in case of uplink communication using the PUSCH, the DMRSs are transmitted from the wireless device 208 to the RNN 210. In other words, the DMRSs may be transmitted according to the DMRS configuration both in the downlink and in the uplink. Further in case of uplink transmission of the DMRSs, it should be understood that the wireless device 208 may be referred to as the transmitter and the RNN 210 may be referred to as the receiver. The need for extrapolation is avoided since interpolation between the DMRSs of the same subframe, e.g. between the DMRSs in an OFDM symbol in the beginning and in the end of the subframe, is sufficient to determine the channel, e.g. to estimate the frequency error.

In some embodiments, wherein the DMRSs are placed in the very first and very last OFDM-symbols of the subframe, then only interpolation between the two OFDM symbols comprising DMRSs is needed in order to obtain the channel, e.g. to determine the channel or to determine the frequency error, for a given antenna port at any OFDM symbol in the subframe. Thus, in such embodiments, the wireless device 208 only needs to interpolate between the two OFDM symbols, e.g. the first and second OFDM symbols, comprising DMRSs. Interpolation is generally preferred over extrapolation due to performance, e.g. due to improved performance. However, in some embodiments, there is typically one or a few OFDM-symbols before the first OFDM-symbol with DMRS and after the last, e.g. the second, OFDM-symbol with DMRS. Cf. FIG. 6. In such embodiments, extrapolation may also be necessary. This relates to Action 805 which will be described below.

The length of the PDSCH or PUSCH region may be indicated in the scheduling control information, e.g. the scheduling DCI. Hence, the positions of the first and/or the one or more second OFDM symbol(s) comprising DMRSs in the subframe are variable, depending on the information in the scheduling message, e.g. scheduling DCI message.

In some embodiments for the downlink, the receiver, e.g. the wireless device 208, indicates to the transmitter, e.g. the RNN 210, with a feedback channel, such as a Channel-State Information (CSI) feedback, whether one or more than one OFDM symbol(s) comprising DMRSs for an antenna port, e.g. a PDSCH antenna port or a PUSCH channel, is recommended. In this disclosure the expression “feedback channel” may be referred to as a feedback signal or a response signal, and it should be understood that the terms may be used interchangeably.

The Channel-State Information is a general term for information describing characteristics of the radio channel, such as indicating the complex transfer function matrix between one or more transmit antennas and one or more receive antennas.

The receiver, e.g. the wireless device 208, may base its feedback indication, e.g. its feedback signal, on an estimate of its speed or whether it is stationary or not. Alternatively or additionally, the receiver, e.g. the wireless device 208, may base its feedback indication on an estimate of the frequency error. For example, if the system is using two OFDM symbols comprising DMRSs, e.g. the first and second OFDM symbols, per subframe or TTI, the wireless device 208 may continuously estimate the frequency error and report it back to the transmitter, e.g. the RNN 210. The RNN 210 may then decide that one DMRS-carrying OFDM symbol, e.g. the first OFDM symbol, is enough when the reported error goes below a given threshold.

However, it should be understood that the feedback indication may be based on other types of decision criteria. For example, the wireless device 208 may compare channel estimates from successive TTIs and conclude that they are very similar, thus indicating a non-varying channel which would allow for the usage of only one DMRS-carrying OFDM symbol, e.g. the first OFDM symbol.

This relates to Actions 307-308, and 406 previously described. This also relates to Actions 806 and 807 which will be described below.

In some embodiments relating to for example Actions 305 and 404 previously described, the indication transmitted from the transmitter, e.g. the RNN 210, to the receiver, e.g. the wireless device 208, is not explicit in the scheduling message, e.g. in the scheduling DCI message, but rather depends implicitly on at least one or a combination of multiple of the information fields in the scheduling message, such as one or more of:
Modulation constellation. For example, a Quadrature Phase-Shift Keying (QPSK) modulation may imply that one OFDM symbol comprising DMRSs should be used, while other modulations may imply that more than one OFDM symbols comprising DMRSs, e.g. the first and second OFDM symbols, should be used.
Modulation and Coding Scheme (MCS). For example, an MCS >x may imply that only one OFDM symbols comprising DMRS should be used.
Number of Multiple Input Multiple Output (MIMO) layers. For example, a rank 1 may imply that one OFDM symbol comprising DMRSs should be used, while other ranks may imply that more than one OFDM symbols comprising DMRSs should be used.
Radio Network Temporary Identifier (RNTI) type. For example, an RNTI associated with time-critical data may imply that one OFDM symbol comprising DMRSs should be used, while other RNTIs may imply that more than one OFDM symbols comprising DMRSs should be used.

In some embodiments, the indication depends on whether or not the scheduling message was received by a control-channel candidate associated with time-critical scheduling. By the expression “a control-channel candidate associated with time-critical scheduling” when used herein is meant that some control-channel elements may be designated, e.g. by the standard, to carry scheduling information relating to time-critical transmissions. Thus, in some embodiments, the indications depend on whether or not the scheduling message was received by a control-channel element designated for a time-critical transmission.

In some embodiments, the RNN 210 may dynamically switch on or off the one or more second OFDM symbols comprising the DMRSs to for example periodically schedule two or more OFDM symbols comprising DMRSs in a subframe.

In the downlink, the wireless device 208 may for example estimate the frequency error or compare the channel estimation and/or determine a Signal-to-Interference-plus-Noise Ratio (SINR) between two neighboring subframes with and without the one or more second OFDM symbols comprising the DRMSs in addition to the first OFDM symbols comprising the DMRSs. Based on the comparison, the wireless device 208 may determine whether one OFDM symbol comprising DMRSs, e.g. the first OFDM symbol comprising DMRSs, is sufficient or whether one or more further OFDM symbols comprising DMRSs, e.g. one or more second OFDM symbols comprising DMRSs, are needed.

By the expression “neighboring subframes” when used in this disclosure is meant subframes that are subsequent, or near-subsequent, in time. How many subframes apart two subframes may be and still be referred to as neighboring subframes depends on how fast the channel conditions vary over time.

In the downlink, the RNN 210 may for example, ask or request the receiver, e.g. the wireless device 208, to report a measured frequency error, e.g. an estimated frequency error, to the RNN 210 via for example Radio-Resource Control (RRC) signaling or Uplink Control Information (UCI). If the estimated frequency error is larger than a first predefined or predetermined value x kHz or if the difference between a first SINR value when using two OFDM symbols comprising DMRSs, SINR_{2-DMRS}, and a second SINR value when using one OFDM symbol comprising DMRSs, SINR_{1-DMRS}, e.g. SINR_{2-DMRS}−SINR_{1-DMRS}, is larger than a second predefined or predetermined value y, the RNN 210 may be configured to schedule two OFDM symbols comprising DMRSs, e.g. the first and second OFDM symbols comprising DMRSs else the RNN 210 may be configured to schedule one OFDM symbol comprising DMRSs, e.g. the first OFDM symbol comprising DMRSs.

This relates to Actions 301-303, and 401 and 402 previously described.

In some embodiments, the one or more second OFDM symbols comprising DMRSs may be dynamically switched on or off. For example, the RNN 210 may be configured to dynamically switch on or off the one or more second OFDM symbols comprising DMRSs. Thus, the RNN 210 may periodically schedule one DMRS and two DMRSs, respectively, in one or several subsequent OFDM subframes, see the table below for one example.

| | | | | | |
|---|---|---|---|---|---|
| Subframe | 0 | 1 | 2 | 3 | . . . |
| No. of DMRS | 1 | 2 | 1 | 2 | . . . |

By using the same coding rate in both the subframe 2n and in the subframe 2n+1 and by comparing the performance, e.g. the spectral efficiency, the RNN 210 may choose one or two OFDM symbols comprising DMRSs based on the comparison. This relates to Actions 304 and 403 previously described.

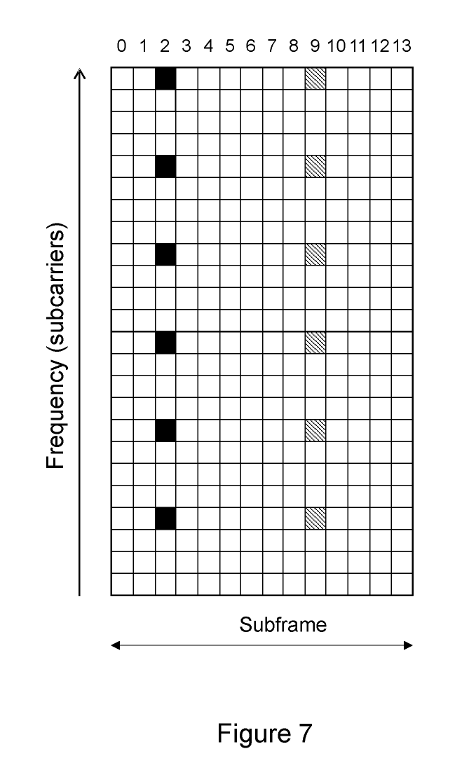

FIG. 7 schematically illustrates a second exemplary DMRS-configuration according to embodiments disclosed herein.

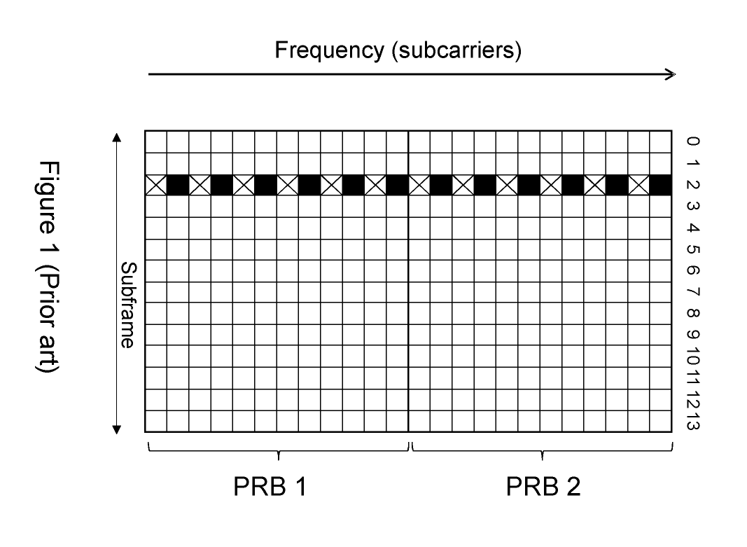

In FIG. 7, a first set of DMRSs for a first transmission on a first antenna port are placed on every fourth subcarrier on the first OFDM symbol, e.g. the OFDM symbol number 2. The DMRSs of the first set of DMRSs are shown as filled squares in FIG. 7. A second set of DMRSs for the first transmission on the first antenna port are placed on every fourth subcarrier on the second OFDM symbol, e.g. the OFDM symbol number 9. The DMRSs of the second set of DMRSs are indicated with downward diagonal lines. Thus, each DMRS of the first set is placed on the same subcarrier as one DMRS of the second set. Further, in the example illustrated in FIG. 7, the total number of resource Elements (RE) used for the DMRSs of the first transmission is unchanged as compared to the total number of REs used in the legacy case illustrated in FIG. 1. Thereby, the same number of PDSCH or PUSCH REs for that layer, e.g. that antenna port, is available for the transmission, irrespective of whether one or several OFDM symbols comprise DMRSs.

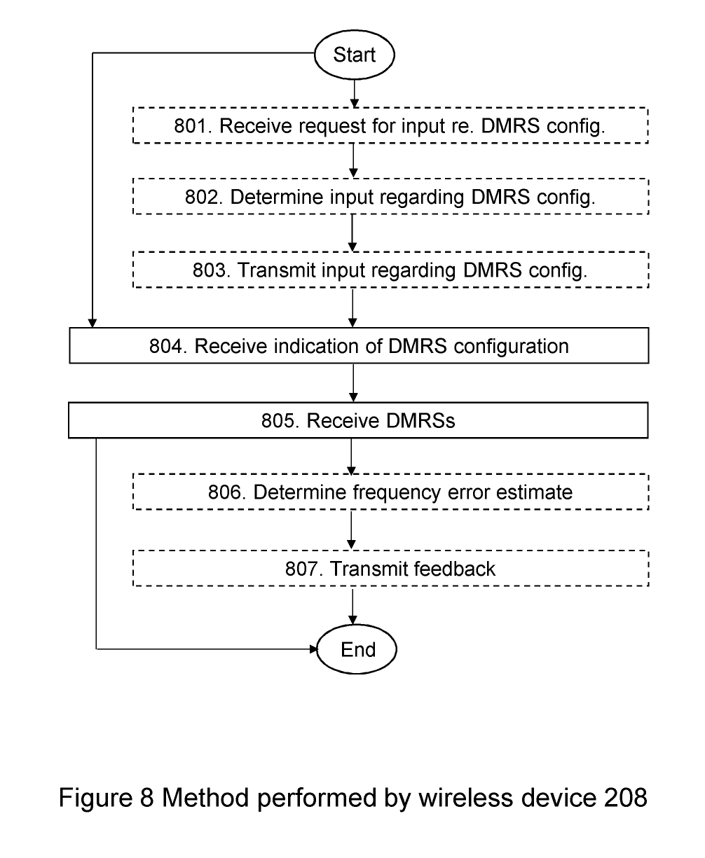

Examples of methods performed by the wireless device 208 for receiving RSs, e.g. DMRSs, will now be described with reference to flowchart depicted in FIG. 8. As previously described, the RNN 210 and the wireless device 208 are configured to operate in the wireless communications network 200.

The methods comprise one or more of the following actions. Thus, one or more of the actions may be optional. It should be understood that the actions may be taken in any suitable order and that some actions may be combined.

Action 801

In some embodiments, the wireless device 208 receives, from the RNN 210, a request for input relating to a DMRS configuration.

This relates to Actions 301 and 401 previously described.

Action 802

The wireless device 208 may determine input regarding the DMRS configuration. This may be done in response to the request received in Action 802.

As previously described, if the wireless device 208 is stationary or is moving at a low speed or in the case of time-critical decoding, the input from the wireless device 208 may be that one OFDM symbol comprising the DMRSs, e.g. one OFDM symbol in the beginning of the subframe, is preferred. Examples of time-critical decoding is low-latency applications such as remote control and tactile internet applications just to mention some. However, if the wireless device 208 is moving at a high speed or in the case of non-time-critical decoding, the input from the wireless device 208 may be that two or more OFDM symbols comprising the DMRSs are preferred. Examples of non-time-critical decoding is when the data transmission is a file transfer, web browsing or non-delay sensitive applications, just to mention some.

This relates to Action 302 previously described.

Action 803

The wireless device 208 may transmit, to the RNN 210, the determined input regarding DMRS configuration.

This relates to Action 303 previously described.

Action 804

The wireless device 208 receives, from the RNN 210, an indication of the DMRS configuration. As previously mentioned the indication may be an explicit indication or an implicit indication.

As previously mentioned, the DMRS configuration may be dynamically configurable to relate to one or more out of a first OFDM symbol comprising DMRSs for a first transmission, and a second OFDM symbol comprising DMRSs for the first transmission.

This relates to Actions 305 and 404 previously described.

Action 805

The wireless device 208 receives, from the RNN 210, DMRSs. The DMRSs are transmitted in accordance with the DMRS configuration.

This relates to Actions 306 and 404 previously described.

Action 806

The wireless device 208 may determine a frequency-error estimate based on one or more of the received DMRSs.

This relates to Action 307 previously described.

Action 807

The wireless device 208 may transmit, to the RNN 210, a feedback. The feedback may comprise the determined frequency-error estimate or information relating thereto. As mentioned above, the feedback may be transmitted over a feedback channel.

It should also be understood that the wireless device 208 may transmit, to the RNN 210, feedback relating to the DMRSs in accordance with the DMRS configuration.

Further, it should be understood that in some embodiments, the wireless device 208 transmits DMRS in accordance with a DMRS configuration.

This relates to Action 308 previously described.

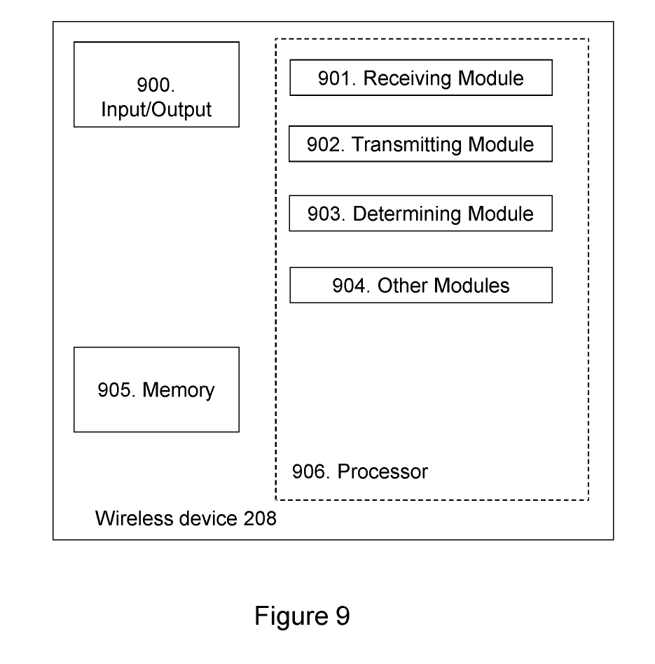

To perform the method for receiving RSs, e.g. DMRSs, the wireless device 208 may be configured according to an arrangement depicted in FIG. 9. As previously mentioned, the RNN 210 and the wireless device 208 are operating in the wireless communications network 200.

In some embodiments, the wireless device 208 comprises an input and output interface 900 configured to communicate with one or more the communications devices, and one or more network nodes, e.g. the network node 206, the RNN 210 or a neighbour RNN (not shown). The input and output interface 900 may comprise a wireless receiver (not shown) and a wireless transmitter (not shown).

The wireless device 208 is configured to receive, e.g. by means of a receiving module 901 configured to receive, transmissions from the RNN 210. The receiving module 901 may be implemented by or arranged in communication with a processor 906 of the wireless device 208. The processor 906 will be described in more detail below.

In some embodiments, the wireless device 208 is configured to receive, from the RNN 210, a request for input relating to a DMRS configuration. Further, the wireless device 208 may be configured to receive, from the RNN 210, an indication of the DMRS configuration. Furthermore, the wireless device 208 may be configured to receive, from the RNN 210, DMRSs transmitted in accordance with the DMRS configuration.

The wireless device 208 is configured to transmit, e.g. by means of a transmitting module 902 configured to transmit, transmissions, e.g. data or information, to the RNN 210. The transmitting module 902 may be implemented by or arranged in communication with the processor 907 of the wireless device 208.

The wireless device 208 may be configured to transmit, to the RNN 210, an input regarding DMRS configuration. Further, the wireless device 208 may be configured to transmit, to the RNN 210, a feedback. Furthermore, the wireless device 208 may configured to transmit, to the RNN 210, feedback relating to the DMRSs in accordance with the DMRS configuration. Further, it should be understood that in some embodiments, the wireless device 208 is configured to transmit DMRS in accordance with a DMRS configuration.

The wireless device 208 is configured to determine, e.g. by means of a determining module 903 configured to determine, an input or feedback. The determining module 903 may be implemented by or arranged in communication with the processor 906 of the wireless device 208.

The wireless device 208 may be configured to perform, e.g. by one or more other modules 904, one or more other actions described herein.

The wireless device 208 may also comprise means for storing data. In some embodiments, the wireless device 208 comprises a memory 905 configured to store the data. The data may be processed or non-processed data and/or information relating thereto. The memory 905 may comprise one or more memory units. Further, the memory 905 may be a computer data storage or a semiconductor memory such as a computer memory, a read-only memory, a volatile memory or a non-volatile memory. The memory is arranged to be used to store obtained information, data, configurations, schedulings, and applications etc. to perform the methods herein when being executed in the wireless device 208.

Embodiments herein for enabling configurations of RSs, e.g. DMRSs, may be implemented through one or more processors, such as the processor 906 in the arrangement depicted in FIG. 9, together with computer program code for performing the functions and/or method actions of embodiments herein. The program code mentioned above may also be provided as a computer program product, for instance in the form of a data carrier carrying computer program code for performing the embodiments herein when being loaded into the wireless device 208. One such carrier may be in the form of an electronic signal, an optical signal, a radio signal or a computer-readable storage medium. The computer-readable storage medium may be a CD ROM disc or a memory stick.

The computer program code may furthermore be provided as program code stored on a server and downloaded to the wireless device 208.

Those skilled in the art will also appreciate that the input/output interface 900, the receiving module 901, the transmitting module 902, the determining module 903, and the one or more other modules 904 above may refer to a combination of analog and digital circuits, and/or one or more processors configured with software and/or firmware, e.g. stored in the memory 905, that when executed by the one or more processors such as the processors in the wireless device 208 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

### EXEMPLIFYING EMBODIMENTS

### Embodiment 1

A method performed by a Radio Network Node, RNN, (210) for configuration of Demodulation Reference Signals, DMRSs, of a wireless device (208), wherein the RNN (210) and the wireless device (208) are operating in a wireless communications network (200), and wherein the method comprises:
indicating (305, 404) a DMRS configuration to the wireless device (208), which DMRS configuration is dynamically configurable to relate to one or more out of:
   a first Orthogonal Frequency-Division Multiplexing, OFDM, symbol comprising DMRSs for a first transmission; and
   a second OFDM symbol comprising DMRSs for the first transmission.

### Embodiment 2

The method of Embodiment 1, wherein the first and second OFDM symbols are comprised in a single subframe.

### Embodiment 3

The method of Embodiment 2, wherein the first OFDM symbol is located in a beginning of the subframe and the second OFDM symbol is located in an end of the subframe.

### Embodiment 4

The method of any one of Embodiments 1-3, wherein DMRSs of a first set of DMRSs for the first transmission on a first antenna port are placed on every second subcarrier of the first OFDM symbol, and wherein DMRSs of a second set of DMRSs for the first transmission are placed on every second subcarrier of the second OFDM symbol.

### Embodiment 5

The method of any one of Embodiments 1-3, wherein DMRSs of a first set of DMRSs for the first transmission on a first antenna port are placed on every fourth subcarrier of the first OFDM symbol, and wherein DMRSs of a second set of DMRSs for the first transmission are placed on every fourth subcarrier of the second OFDM symbol.

### Embodiment 6

The method of any one of Embodiments 1-5, wherein the indicating (305, 404) of the DMRS configuration to the wireless device (208) comprises:
indicating the DMRS configuration by transmitting, to the wireless device (208), an indicator indicating the second OFDM symbol comprising DMRSs, wherein the indicator is a single bit or a flag.

### Embodiment 7

The method of any one of Embodiments 1-5, wherein the indicating (305, 404) of the DMRS configuration to the wireless device (208) comprises:
indicating the DMRS configuration in a scheduling message transmitted to the wireless device (208).

### Embodiment 8

The method of any one of Embodiments 1-7, comprising:
transmitting (306, 405), to the wireless device (208), the DMRSs in accordance with the DMRS configuration.

### Embodiment 9

The method of any one of Embodiments 1-8, comprising:
receiving, from the wireless device (208), DMRSs transmitted in accordance with the DMRS configuration or feedback relating to the DMRSs transmitted, from the RNN (210) to the wireless device (208), in accordance with the DMRS configuration.

### Embodiment 10

A method performed by a wireless device (208) for configuration of Demodulation Reference Signals, DMRSs, wherein the wireless device (208) and a RNN (210) are operating in a wireless communications network (200), and wherein the method comprises:
receiving (305, 804), from the RNN (210), an indication of a DMRS configuration, which DMRS configuration is dynamically configurable to relate to one or more out of:
   a first Orthogonal Frequency-Division Multiplexing, OFDM, symbol comprising DMRSs for a first transmission; and
   a second OFDM symbol comprising DMRSs for the first transmission.

### Embodiment 11

The method of Embodiment 10, wherein the first and second OFDM symbols are comprised in a single subframe.

### Embodiment 12

The method of Embodiment 11, wherein the first OFDM symbol is located in a beginning of a subframe and the second OFDM symbol is located in an end of the subframe.

### Embodiment 13

The method of any one of Embodiments 10-12, wherein DMRSs of a first set of DMRSs for the first transmission on the first antenna port are placed on every second subcarrier of the first OFDM symbol, and wherein DMRSs of a second set of DMRSs for the first transmission are placed on every second subcarrier of the second OFDM symbol.

### Embodiment 14

The method of any one of Embodiments 10-12, wherein DMRSs of a first set of DMRSs for the first transmission on the first antenna port are placed on every fourth subcarrier of the first OFDM symbol, and wherein DMRSs of a second set of DMRSs for the first transmission are placed on every fourth subcarrier of the second OFDM symbol.

### Embodiment 15

The method of any one of Embodiments 10-14, wherein the indication is an indicator indicating the second OFDM symbol comprising DMRSs, and wherein the indicator is a single bit or a flag.

### Embodiment 16

The method of any one of Embodiments 10-14, wherein the indication is a scheduling message indicating the DMRS configuration.

### Embodiment 17

The method of any one of Embodiments 10-16, comprising:
receiving (306, 805), from the RNN (210), the DMRSs transmitted in accordance with the DMRS configuration.

### Embodiment 18

The method of any one of Embodiments 10-17, comprising:
transmitting, to the RNN (210), DMRSs in accordance with the DMRS configuration, or feedback relating to the DMRSs transmitted, from the RNN (210) to the wireless device (208), in accordance with the DMRS configuration.

### Embodiment 19

A Radio Network Node, RNN, (210) for configuration of Demodulation Reference Signals, DMRSs, of a wireless device (208), wherein the RNN (210) and the wireless device (208) are configured to operate in a wireless communications network (200), and wherein the RNN (210) is configured to:
indicate a DMRS configuration to the wireless device (208), which DMRS configuration is dynamically configurable to relate to one or more out of:
   a first Orthogonal Frequency-Division Multiplexing, OFDM, symbol comprising DMRSs for a first transmission; and
   a second OFDM symbol comprising DMRSs for the first transmission.

### Embodiment 20

The RNN (210) of Embodiment 19, wherein the first and second OFDM symbols are comprised in a single subframe.

### Embodiment 21

The RNN (210) of Embodiment 20, wherein the first OFDM symbol is located in a beginning of the subframe and the second OFDM symbol is located in an end of the subframe.

### Embodiment 22

The RNN (210) of any one of Embodiments 19-21, wherein DMRSs of a first set of DMRSs for the first transmission on a first antenna port are placed on every second subcarrier of the first OFDM symbol, and wherein DMRSs of a second set of DMRSs for the first transmission are placed on every second subcarrier of the second OFDM symbol.

### Embodiment 23

The RNN (210) of any one of Embodiments 19-21, wherein DMRSs of a first set of DMRSs for the first transmission on a first antenna port are placed on every fourth subcarrier of the first OFDM symbol, and wherein DMRSs of a second set of DMRSs for the first transmission are placed on every fourth subcarrier of the second OFDM symbol.

### Embodiment 24

The RNN (210) of any one of Embodiments 19-23, wherein the RNN (210) is configured to indicate the DMRS configuration by transmitting, to the wireless device (208), an indicator indicating the second OFDM symbol comprising DMRSs, wherein the indicator is a single bit or a flag.

### Embodiment 25

The RNN (210) of any one of Embodiments 19-23, wherein the RNN (210) is configured to indicate the DMRS configuration in a scheduling message transmitted to the wireless device (208).

### Embodiment 26

The RNN (210) of any one of Embodiments 19-25, configured to:
transmit, to the wireless device (208), the DMRSs in accordance with the DMRS configuration.

### Embodiment 27

The RNN (210) of any one of Embodiments 19-26, configured to:
receive, from the wireless device (208), DMRSs transmitted in accordance with the DMRS configuration or feedback relating to the DMRSs transmitted, from the RNN (210) to the wireless device (208), in accordance with the DMRS configuration.

### Embodiment 28

A wireless device (208) for configuration of Demodulation Reference Signals, DMRSs, wherein the wireless device (208) and a RNN (210) are operating in a wireless communications network (200), and wherein the wireless device (208) is configured to:
receive, from the RNN (210), an indication of a DMRS configuration, which DMRS configuration is dynamically configurable to relate to one or more out of:
   a first Orthogonal Frequency-Division Multiplexing, OFDM, symbol comprising DMRSs for a first transmission; and
   a second OFDM symbol comprising DMRSs for the first transmission.

### Embodiment 29

The wireless device (208) of Embodiment 28, wherein the first and second OFDM symbols are comprised in a single subframe.

### Embodiment 30

The wireless device (208) of Embodiment 29, wherein the first OFDM symbol is located in a beginning of a subframe and the second OFDM symbol is located in an end of the subframe.

### Embodiment 31

The wireless device (208) of any one of Embodiments 28-30, wherein DMRSs of a first set of DMRSs for the first transmission on the first antenna port are placed on every second subcarrier of the first OFDM symbol, and wherein DMRSs of a second set of DMRSs for the first transmission are placed on every second subcarrier of the second OFDM symbol.

### Embodiment 32

The wireless device (208) of any one of Embodiments 28-30, wherein DMRSs of a first set of DMRSs for the first transmission on the first antenna port are placed on every fourth subcarrier of the first OFDM symbol, and wherein DMRSs of a second set of DMRSs for the first transmission are placed on every fourth subcarrier of the second OFDM symbol.

### Embodiment 33

The wireless device (208) of any one of Embodiments 28-32, wherein the indication is an indicator indicating the second OFDM symbol comprising DMRSs, and wherein the indicator is a single bit or a flag.

### Embodiment 34

The wireless device (208) of any one of Embodiments 28-32, wherein the indication is a scheduling message indicating the DMRS configuration.

### Embodiment 35

The wireless device (208) of any one of Embodiments 28-34, configured to:
receive, from the RNN (210), the DMRSs transmitted in accordance with the DMRS configuration.

### Embodiment 36

The wireless device (208) of any one of Embodiments 28-35, configured to:
transmit, to the RNN (210), DMRSs in accordance with the DMRS configuration or feedback relating to the DMRSs transmitted from the RNN (210) to the wireless device (208) in accordance with the DMRS configuration.

### Embodiment 37

A computer program, comprising instructions which, when executed on at least one processor, causes the at least one processor to carry out the method according to any one of embodiments 1-18.

### Embodiment 38

A carrier comprising the computer program of Embodiment 37, wherein the carrier is one of an electronic signal, an optical signal, a radio signal, or a computer-readable storage medium.

### Embodiment 39

A Radio Network Node, RNN, (210) for configuration of Demodulation Reference Signals, DMRSs, of a wireless device (208), wherein the RNN (210) and the wireless device (208) are configured to operate in a wireless communications network (200), wherein the RNN (210) comprises a processor (507) and a memory (506), and wherein the memory (506) comprises instructions executable by the processor (507) whereby the RNN (210) is operative to:
indicate a DMRS configuration to the wireless device (208), which DMRS configuration is dynamically configurable to relate to one or more out of:
   a first Orthogonal Frequency-Division Multiplexing, OFDM, symbol comprising DMRSs for a first transmission; and
   a second OFDM symbol comprising DMRSs for the first transmission.

### Embodiment 40

A wireless device (208) for configuration of Demodulation Reference Signals, DMRSs, wherein the wireless device (208) and a RNN (210) are operating in a wireless communications network (200), wherein the wireless device (208) comprises a processor (507) and a memory (506), and wherein the memory (506) comprises instructions executable by the processor (507) whereby the wireless device (208) is operative to:
receive, from the RNN (210), an indication of a DMRS configuration, which DMRS configuration is dynamically configurable to relate to one or more out of:
   a first Orthogonal Frequency-Division Multiplexing, OFDM, symbol comprising DMRSs for a first transmission; and
   a second OFDM symbol comprising DMRSs for the first transmission.

### Embodiment 41

A Radio Network Node, RNN, (210) for configuration of Demodulation Reference Signals, DMRSs, of a wireless device (208), wherein the RNN (210) and the wireless device (208) are configured to operate in a wireless communications network (200), and wherein the RNN (210) comprises:
a module (505) configured to indicate a DMRS configuration to the wireless device (208), which DMRS configuration is dynamically configurable to relate to one or more out of:
   a first Orthogonal Frequency-Division Multiplexing, OFDM, symbol comprising DMRSs for a first transmission; and
   a second OFDM symbol comprising DMRSs for the first transmission.

### Embodiment 42

A wireless device (208) for configuration of Demodulation Reference Signals, DMRSs, wherein the wireless device (208) and a RNN (210) are operating in a wireless communications network (200), and wherein the wireless device (208) comprises:
a receiving module (901) configured to receive, from the RNN (210), an indication of a DMRS configuration, which DMRS configuration is dynamically configurable to relate to one or more out of:
   a first Orthogonal Frequency-Division Multiplexing, OFDM, symbol comprising DMRSs for a first transmission; and
   a second OFDM symbol comprising DMRSs for the first transmission.

When using the word “comprise” or “comprising” it shall be interpreted as non-limiting, i.e. meaning “consist at least of”.

Modifications and other variants of the described embodiment(s) will come to mind to one skilled in the art having the benefit of teachings presented in the foregoing descriptions and the associated drawings. Therefore, it is to be understood that the embodiment(s) herein is/are not be limited to the specific examples disclosed and that modifications and other variants are intended to be included within the scope of this disclosure. Although specific terms may be employed herein, they are used in a generic and descriptive sense only and not for purposes of limitation.

1-66. (canceled)

67. A method performed by a Radio Network Node, RNN, for configuration of Demodulation Reference Signals, DMRSs, of a wireless device, wherein the RNN and the wireless device are operating in a wireless communications network, and wherein the method comprises:
indicating a DMRS configuration to the wireless device, which DMRS configuration is dynamically configurable to relate to one or more out of:
a first Orthogonal Frequency-Division Multiplexing, OFDM, symbol comprising DMRSs for a first transmission; and
a second OFDM symbol comprising DMRSs for the first transmission.

68. The method of claim 67, wherein the first and second OFDM symbols are comprised in a single subframe.

69. The method of claim 68, wherein the first OFDM symbol is located in a beginning of the subframe and the second OFDM symbol is located in an end of the subframe.

70. The method of claim 67, wherein DMRSs of a first set of DMRSs for the first transmission on a first antenna port are placed on every second subcarrier of the first OFDM symbol, and wherein DMRSs of a second set of DMRSs for the first transmission are placed on every second subcarrier of the second OFDM symbol.

71. The method of claim 67, wherein the indicating of the DMRS configuration to the wireless device comprises:
indicating the DMRS configuration in a scheduling message transmitted to the wireless device.

72. A method performed by a wireless device for configuration of Demodulation Reference Signals, DMRSs, wherein the wireless device and a RNN are operating in a wireless communications network, and wherein the method comprises:
receiving, from the RNN, an indication of a DMRS configuration, which DMRS configuration is dynamically configurable to relate to one or more out of:
a first Orthogonal Frequency-Division Multiplexing, OFDM, symbol comprising DMRSs for a first transmission; and
a second OFDM symbol comprising DMRSs for the first transmission.

73. The method of claim 72, wherein the first and second OFDM symbols are comprised in a single subframe.

74. The method of claim 73 wherein the first OFDM symbol is located in a beginning of a subframe and the second OFDM symbol is located in an end of the subframe.

75. The method of claim 72, wherein DMRSs of a first set of DMRSs for the first transmission on the first antenna port are placed on every second subcarrier of the first OFDM symbol, and wherein DMRSs of a second set of DMRSs for the first transmission are placed on every second subcarrier of the second OFDM symbol.

76. The method of claim 72, wherein the indication is an indicator indicating the second OFDM symbol comprising DMRSs, and wherein the indicator is a single bit or a flag.

77. The method of claim 72, wherein the indication is a scheduling message indicating the DMRS configuration.

78. A Radio Network Node, RNN, for configuration of Demodulation Reference Signals, DMRSs, of a wireless device, wherein the RNN and the wireless device are configured to operate in a wireless communications network, and wherein the RNN comprises:
a processor and a memory, the memory containing instructions executable by the processor whereby the RNN is configured to indicate a DMRS configuration to the wireless device, which DMRS configuration is dynamically configurable to relate to one or more out of:
a first Orthogonal Frequency-Division Multiplexing, OFDM, symbol comprising DMRSs for a first transmission; and
a second OFDM symbol comprising DMRSs for the first transmission.

79. The RNN of claim 78, wherein the first and second OFDM symbols are comprised in a single subframe.

80. The RNN of claim 79, wherein the first OFDM symbol is located in a beginning of the subframe and the second OFDM symbol is located in an end of the subframe.

81. The RNN of claim 78, wherein the RNN is configured to indicate the DMRS configuration in a scheduling message transmitted to the wireless device.

82. A wireless device for configuration of Demodulation Reference Signals, DMRSs, wherein the wireless device and a RNN are operating in a wireless communications network, and wherein the wireless device comprises:
a processor and a memory, the memory containing instructions executable by the processor whereby the wireless device is configured to receive, from the RNN, an indication of a DMRS configuration, which DMRS configuration is dynamically configurable to relate to one or more out of:
a first Orthogonal Frequency-Division Multiplexing, OFDM, symbol comprising DMRSs for a first transmission; and
a second OFDM symbol comprising DMRSs for the first transmission.

83. The wireless device of claim 82, wherein the first and second OFDM symbols are comprised in a single subframe.

84. The wireless device of claim 83, wherein the first OFDM symbol is located in a beginning of a subframe and the second OFDM symbol is located in an end of the subframe.

85. The wireless device of claim 82 wherein DMRSs of a first set of DMRSs for the first transmission on the first antenna port are placed on every second subcarrier of the first OFDM symbol, and wherein DMRSs of a second set of DMRSs for the first transmission are placed on every second subcarrier of the second OFDM symbol.

86. The wireless device of claim 82, wherein the indication is an indicator indicating the second OFDM symbol comprising DMRSs, and wherein the indicator is a single bit or a flag.

87. The wireless device of claim 82, wherein the indication is a scheduling message indicating the DMRS configuration.
